(19) United States
(12) Patent Application Publication
(10) Pub. No.: US 2007/0159350 A1
(43) Pub. Date: Jul. 12, 2007

(54) REMOTE CONTROLLER

(76) Inventor: An-Sheng Chang, Taipei Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,496

(22) Filed: Mar. 30, 2006

(30) Foreign Application Priority Data
Jan. 11, 2006 (TW) 95101038

(51) Int. Cl. G08C 19/00

(52) U.S. Cl. 340/825.69

(57) ABSTRACT

A remote controller includes a first video/audio (AV) trans-receiving device and a second video/audio trans-receiving device. Wherein, the first AV trans-receiving device receives and packs a control command signal to be transmitted in wireless communication. The second AV trans-receiving device is coupled to a cable and communicated with the first AV trans-receiving device through the wireless communication. The second AV trans-receiving device receives a wireless control packet containing a control command signal. In addition, the second AV trans-receiving device selects the channel corresponding to an input-channel signal according to the control command signal, packs the channel that is selected by the user, and transmits it to the first AV trans-receiving device in the wireless communication. Finally, the first AV trans-receiving device receives a wireless AV packet that contains the selected channel to generate an output AV signal.

### CROSS-REFERENCE TO RELATED APPLICATION

This application claims the priority benefit of Taiwan application serial no. 95101038, filed on Jan. 11, 2006. All disclosure of the Taiwan application is incorporated herein by reference.

### BACKGROUND OF THE INVENTION

1. Field of the Invention

The present invention relates to a remote controller, and more particularly, to a remote controller that uses a wireless transmission technique.

2. Description of the Related Art

Recently, with tremendously releasing cable TV channels and the versatility of audio/video (abbreviated as AV hereinafter) content of the channels, a user's demanding for acquiring information from the cable TV channels becomes more aggressively. For example, the users can acquire information such as news, financial information, and shopping information from various shopping channels. Here, the cable TV channels include education programs, entertainment programs, traveling programs, and even movies. However, as each user desires different information, it is common that many families may require more than one television to fulfill different needs for each folk of the family.

To watch the TV channels, the television must be connected to a channel transmission equipment for the cable TV channel proprietor through a cable, and in some cases a special receiver, such as, a digital set-top box must be added to the television. Therefore, each time when a new television is bought, an additional cable (even an extra set-top box) is required. In some situations, the new television is usually disposed at a location (or a room) outside a living room, thus the wiring of the cable for connecting the television needs to be extended. In addition, the user usually layouts the cable for connecting the television in an uncovered manner, and some additional fixing parts are usually used to fix the cable, which messes up the original interior environment. Furthermore, if the layout design of the cable is poor, it increases the inconvenience of the user's activity and can even stumble the user who is accordingly injured.

In addition, since the cable has a fixed layout in the aforementioned method, once the television is relocated, the wiring has to be re-cabled, which requires much time consumed and laborious work. Moreover, as the TV is connected through the cable, the flexibility for the TV location is lowered, and the user cannot obtain the desired information on any location due to the TV's space-limited location.

### SUMMARY OF THE INVENTION

Therefore, an object of the present invention is to provide a remote controller, which help a user acquire the desired information on any location.

To achieve the object mentioned above and others, the present invention provides a remote controller. The remote controller has a cable connector for being connected to the channel transmission equipment of a channel proprietor to receive a channel signal provided by the channel proprietor. The remote controller provided by the present invention includes a first video/audio (AV) trans-receiving device and a second video/audio trans-receiving device. Wherein, the first AV trans-receiving device receives a control command signal and packs it to be transmitted in wireless communication. The second AV trans-receiving device communicates with the first AV trans-receiving device through a wireless communication. The second AV trans-receiving device receives the wireless control packet containing the control command signal. In addition, the second AV trans-receiving device selects a channel according to the control command signal, packs the channel selected by the user, and transfers it to the first AV trans-receiving device in the wireless communication. Finally, the first AV trans-receiving device receives the wireless AV packet that contains the selected channel and then generates an output AV signal.

In accordance with a preferred embodiment of the present invention, in the remote controller mentioned above, the first AV trans-receiving device comprises a receiver, a first processor, a first wireless transmission module, and a signal output device. Wherein, the receiver receives a control command signal input by the user, and the first processor is coupled to the receiver. The first wireless transmission module is coupled to the first processor to receive a wireless AV packet transmitted by the second AV trans-receiving device, and outputs an unpacked wireless AV packet after it is unpacked. In addition, the first wireless transmission module receives the control command signal through the first processor and the receiver, packs the control command signal to generate a wireless control packet that contains the control command signal, and then transmits the wireless control packet in wireless communication. The signal output device is coupled to the first processor and receives an output from the first wireless transmission module through the first processor. Then, the signal output device generates an output AV signal according to the output of the first wireless transmission module.

In accordance with a preferred embodiment of the present invention, in the aforementioned remote controller, the second AV trans-receiving device comprises a second wireless transmission module, a second processor, a channel selection device, and an image extracting device. Wherein, the second wireless transmission module receives the wireless control packet that is transmitted by the first AV trans-receiving device, and outputs the unpacked wireless control packet after it is unpacked. The second processor is coupled to the second wireless transmission module, and the channel selection device is coupled to the second processor. The image extracting device is respectively coupled to the cable connector, the channel selection device, and the second processor to receive an input-channel signal provided through the cable. In addition, the image extracting device sequentially receives an output from the second wireless transmission module through the channel selection device and the second processor. Moreover, the image extracting device selects a channel corresponding to the input-channel signal in accordance with the output of the second wireless transmission module, and provides the selected channel to the second processor. Then, the second processor compresses AV contents of the channel, and provides the compressed contents to the second transmission module. Finally, the second transmission module packs the output of the second processor to generate a wireless AV packet that contains the AV contents of the channel, and transmits the wireless AV packet in the wireless communication.

In accordance with the preferred embodiment of the present invention, the first wireless transmission module in the first AV trans-receiving device of the aforementioned remote controller may be a Wireless Fidelity (Wi-Fi) transmission module.

In accordance with the preferred embodiment of the present invention, the second wireless transmission module in the second AV trans-receiving device of the aforementioned remote controller may be a Wireless Fidelity (Wi-Fi) transmission module.

In summary, a remote controller with a wireless transmission technique is applied in the present invention uses. Accordingly, as long as this remote controller is installed between the television or the LCD display and the cable by the user, the television or the LCD display can be installed at any desired location without being limited by the physical cable layout.

### BRIEF DESCRIPTION DRAWINGS

The accompanying drawings are included to provide a further understanding of the invention, and are incorporated in and constitute a portion of this specification. The drawings illustrate embodiments of the invention, and together with the description, serve to explain the principles of the invention.

FIG. 1 schematically shows a circuit block diagram of a remote controller according to a preferred embodiment of the present invention.

### DESCRIPTION PREFERRED EMBODIMENTS

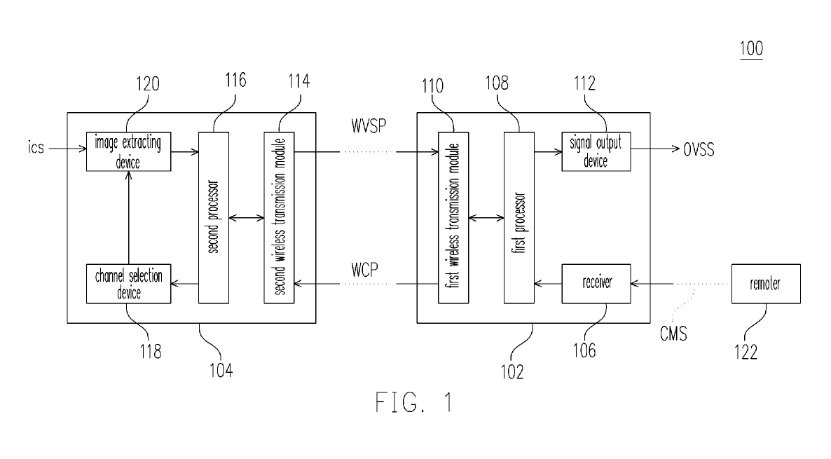

FIG. 1 schematically shows a circuit block diagram of a remote controller according to a preferred embodiment of the present invention. Referring to FIG. 1, the remote controller 100 comprises a first AV trans-receiving device 102 and a second AV trans-receiving device 104. Wherein, the first AV trans-receiving device 102 and the second AV trans-receiving device 104 are communicated with each other in wireless communication. The first AV trans-receiving device 102 receives a wireless AV packet WVSP transmitted by the second AV trans-receiving device 104 and a control command signal CMS input by the user. In addition, the first AV trans-receiving device 102 generates an output AV signal OVSS according to the wireless AV packet WVSP, and generates a wireless control packet WCP that contains the control command signal CMS. Moreover, the second AV trans-receiving device 104 is coupled to a cable that is connected to the channel transmission equipment of a channel proprietor through a cable connector of the remote controller, such that the second AV trans-receiving device 104 can receive an input-channel signal is provided by the channel proprietor and the wireless control packet WCP transmitted by the first AV trans-receiving device 102. Furthermore, the second AV trans-receiving device 104 selects a channel of the input-channel signal is, and further generates the wireless AV packet WVSP that contains the selected channel.

Wherein, the first AV trans-receiving device 102 comprises a receiver 106, a first processor 108, a first wireless transmission module 110, and a signal output device 112. The first processor 108 is coupled to the receiver 106 and the signal output device 112, and the first wireless transmission module 110 is coupled to the first processor 108. The second AV trans-receiving device 104 comprises a second wireless transmission module 114, a second processor 116, a channel selection device 118, and an image extracting device 120. The second processor 116 is coupled to the second wireless transmission module 114, and the channel selection device 118 is coupled to the second processor 116. The image extracting device 120 is respectively coupled to the second processor 116 and the channel selection apparatus 118. Moreover, the image extracting device 120 is coupled to a cable, which is connected from the channel transmission equipment of the channel proprietor to the user's house, through a cable connector.

In the present preferred embodiment, the first wireless transmission module 110 and the second wireless transmission module 114 may be the Wireless Fidelity (Wi-Fi) transmission modules, and the compressed wireless AV packet and the wireless control packet are transmitted by using a wireless communication protocol. However, in other applications of the present invention, it may use, for example, but not limited to, any type of the wireless transmission module. To easily describe the present invention, the operations of the first AV trans-receiving device 102 and the second AV trans-receiving device 104 are described together hereinafter.

First, the receiver 106 receives a control command signal CMS input by the user, and outputs a control signal according to the control command signal CMS. Then, the first processor 108 receives the control signal and compresses the control signal into a compressed control signal that is then sent to the first wireless transmission module 110. Then, the first wireless transmission module 110 generates a wireless control packet WCP from the received compressed control signal in accordance with the Wi-Fi communication protocol. Wherein, the wireless control packet WCP contains the control command signal CMS whose format had been transformed many times. Here, the multiple times of format transformation indicates that the control command signal CMS is sequentially processed and transformed by the receiver 106, the first processor 108, and the first wireless transmission module 110, such that the signal format has been changed many times. However, the content of the signal after being processed and transformed still contain the content of the control command signal CMS that is originally input by the user. Moreover, the first wireless transmission module 110 transmits the wireless control packet WCP to the second wireless transmission module 114 in the wireless communication.

Then, the second wireless transmission module 114 unpacks the received wireless control packet WCP to recover the compressed control signal output from the first processor 108, and provides the compressed control signal to the second processor 116. The second processor 116 decompresses the compressed control signal to generate a channel control signal, and then provides the channel control signal to the channel selection device 118. The channel selection device 118 generates a channel selection signal according to the channel control signal, and provides the channel selection signal to the image extracting device 120.

The image extracting device 120 extracts and selects a channel corresponding to an input-channel signal is according to the channel selection signal received from the cable, wherein the channel is the one the user desires to watch. Then, the image extracting device 120 provides a channel signal of this channel to the second processor 116. The second processor 116 compresses the received channel signal into a compressed AV signal with a specific format. For example, a image file is compressed with a MPEG format, and an audio file is compressed with a MP3 (MPEG 1 Layer 3) format. Then, the second processor 116 provides the compressed AV signal to the second wireless transmission module 114.

The second wireless transmission module 114 generates a wireless AV packet WVSP from the compressed AV signal in accordance with the Wi-Fi communication protocol. Wherein, the wireless AV packet WVSP contains the selected channel whose format had been transformed many times. Here, the multiple times of format transformation indicates that the selected channel is sequentially processed and transformed by the image extracting device 120, the second processor 116, and the second wireless transmission module 114, such that the signal format has been changed many times. However, the content of the channel after being processed and transformed still contain the content of the selected channel that is originally selected by the user. In addition, the second wireless transmission module 114 transmits the wireless AV packet WVSP to the first wireless transmission module 110.

Then, the first wireless transmission module 110 unpacks the received wireless AV packet WVSP to recover the compressed AV signal output from the second processor 116, and provides the compressed AV signal to the first processor 108. The first processor 108 decompresses the compressed AV signal to generate an AV signal, and then provides the AV signal to the signal output device 112. The signal output device 112 generates an output AV signal OVSS according to the AV signal. Accordingly, as long as the output AV signal OVSS is fed into a signal input terminal of a display (e.g. a television or an LCD display) by the user, the user can watch the desired channel.

In the preferred embodiments mentioned above, the Wi-Fi communication protocol may use the 802.11b or 802.11g Wi-Fi communication protocol standard. However, in other applications of the present invention, it may use, for example, but not limited to, other standard. Moreover, in the aforementioned preferred embodiments, the remote controller 100 may further comprise a wireless controller 122 capable of outputting the control command signal CMS in response to a command input by the user.

In summary, the present invention provides a remote controller that uses a wireless transmission technique, such that as long as the remote controller 100 is installed between the television (or the LCD display) and the cable, the television can be disposed at any desired location and is not limited by the physical cable layout and spatial limitation. Furthermore, as the channel signal is no longer transmitted by the cable, but by the remote controller 100 in the present invention, it is not required to design the cable layout anymore, such that the interior environment is not messed up and the user's safety is maintained.

Although the invention has been described with reference to a particular embodiment thereof, it will be apparent to one of the ordinary skills in the art that modifications to the described embodiment may be made without departing from the spirit of the invention. Accordingly, the scope of the invention will be defined by the attached claims not by the above detailed description.

What is claimed is:

1. A remote controller with a cable connector through which the remote controller is connected to a channel transmission equipment of a channel proprietor for receiving an input-channel signal provided by the channel proprietor, the remote controller comprising:
a first audio/video (AV) trans-receiving device for receiving a control command signal and packing the control command signal for wireless communication; and
a second AV trans-receiving device communicating with the first AV trans-receiving device for receiving a wireless control packet that contains the control command signal, and selecting a channel corresponding to the input-channel signal according to the control command signal, wherein the second AV trans-receiving device packs the selected channel and transmits the packed selected channel to the first AV trans-receiving device, and the first AV trans-receiving device receives a wireless AV packet that contains the selected channel to generate an output AV signal.

2. The remote controller of claim 1, wherein the first AV trans-receiving device comprises:
a receiver for receiving the control command signal;
a first processor coupled to the receiver;
a first wireless transmission module coupled to the first processor, for receiving the wireless AV packet transmitted by the second AV trans-receiving device, unpacking and outputting the wireless AV packet, and then receiving the control command signal through the first processor and the receiver, packing the control command signal to generate the wireless control packet that contains the control command signal, and then transmitting the wireless control packet in wireless transmission; and
a signal output device coupled to the first processor, for receiving an output of the first wireless transmission module through the first processor, and generating an output AV signal according to the output of the first wireless transmission module.

3. The remote controller of claim 2, wherein the first wireless transmission module is a Wireless Fidelity (Wi-Fi) transmission module.

4. The remote controller of claim 2, wherein the wireless control packet is generated in accordance with the 802.11b standard.

5. The remote controller of claim 2, wherein the wireless control packet is generated in accordance with the 802.11g standard.

6. The remote controller of claim 1, wherein the second AV trans-receiving device comprises:
a second wireless transmission module for receiving the wireless control packet transmitted by the first AV trans-receiving device, and unpacking and outputting the wireless control packet;
a second processor coupled to the second wireless transmission module;
a channel selection device coupled to the second processor; and
an image extracting device respectively coupled to a cable, the channel selection device, and the second processor for receiving the input-channel signal provided from the cable, wherein the image extracting device sequentially receives an output of the second wireless transmission module through the channel selection device and the second processor, selects an channel corresponding to the input-channel signal according to the output of the second wireless transmission module, and outputs the channel to the second processor, and the second processor compresses and outputs the AV contents of the channel to the second transmission module, such that the second wireless transmission module packs the output of the second processor to generate the wireless AV packet that contains the channel, and then the second wireless transmission module transmits the wireless AV packet in wireless communication.

7. The remote controller of claim 6, wherein the second wireless transmission module is a Wireless Fidelity (Wi-Fi) transmission module.

8. The remote controller of claim 6, wherein the wireless AV packet is generated in accordance with the 802.11b standard.

9. The remote controller of claim 6, wherein the wireless AV packet is generated in accordance with the 802.11g standard.

10. The remote controller of claim 1, further comprising a wireless controller for receiving a command input by a user, and outputting the control command signal according to the command.
